(19) United States
(12) Patent Application Publication
(10) Pub. No.: US 2026/0127245 A1
(43) Pub. Date: May 7, 2026

(54) AUTOMATICALLY IDENTIFYING AND GENERATING MACHINE LEARNING PREDICTION MODELS FOR DATA INPUT FIELDS

(71) Applicant: ServiceNow, Inc., Santa Clara, CA (US)

(72) Inventors: Virendra Kumar Mehta, Cupertino, CA (US); Sriram Palapudi, Santa Clara, CA (US)

(73) Assignee: ServiceNow, Inc., Santa Clara, CA (US)

(21) Appl. No.: 19/049,527

(22) Filed: Feb. 10, 2025

Related U.S. Application Data
(63) Continuation of application No. 17/035,162, filed on Sep. 28, 2020, now abandoned.

(51) Int. Cl. G06F 18/21; G06F 11/30; G06N 20/00

(52) U.S. Cl. CPC G06F 18/217; G06F 11/3072; G06N 20/00

(57) ABSTRACT

An indication to enable machine learning prediction for a form that includes a plurality of data input fields is received and behavior associated with the form is monitored. One or more of the plurality of data input fields are automatically selected based on an analysis of the monitored behavior. For at least a portion of the selected one or more of the plurality of data input fields, one or more machine learning prediction models are automatically generated. At least a portion of the generated machine learning prediction models are allowed for use in providing one or more prediction results for one or more of the plurality of data input fields.

### CROSS REFERENCE TO RELATED APPLICATIONS

The present application is a continuation of and claims priority to U.S. patent application Ser. No. 17/035,162 filed Sep. 28, 2020, which is hereby incorporated by reference in its entirety.

### BACKGROUND OF THE INVENTION

Data collection can be efficiently performed using digital computer forms to replace traditional paper forms. These digital forms can be served via a web application server and offer a method for users to quickly and efficiently input data that can be later processed.

Moreover, the response fields of the digital forms offer more specificity than paper forms. For example, response fields can provide suggested responses and the responses can have different data types, such as numbers, strings, addresses, dates, names, etc. The use cases are varied and cover a wide spectrum of scenarios. For example, an IT incident report can be quickly inputted electronically and then the incident can be assigned to the appropriate responsible party and its progress tracked. Similarly, a travel reimbursement form can be inputted via a mobile digital computer form and assigned to the appropriate party for processing. In some embodiments, the collection of user data and the subsequent processing and tracking of the process is offered as a software-as-a-service and/or cloud service. Although significantly more efficient than traditional paper forms, as the number of digital forms, the number of response fields per digital form, and the number of options for each field of a form increase, there is a need to improve the efficiency and accuracy associated with completing each form and its corresponding response fields.

### BRIEF DESCRIPTION OF THE DRAWINGS

Various embodiments of the invention are disclosed in the following detailed description and the accompanying drawings.

FIG. 1 is a block diagram illustrating an example of a network environment for automating data input field responses.

FIG. 2 is a flow chart illustrating an embodiment of a process for automating a digital form.

FIG. 3 is a flow chart illustrating an embodiment of a process for configuring the automation of a digital form.

FIG. 4 is a flow chart illustrating an embodiment of a process for monitoring the behaviors associated with a digital form.

FIG. 5 is a flow chart illustrating an embodiment of a process for training a prediction model for automating a digital form.

FIG. 6 is a flow chart illustrating an embodiment of a process for applying machine learning prediction for automating a digital form.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automating the completion of data input fields for digital forms is disclosed. Using the disclosed techniques, digital forms and their response fields are analyzed and fields appropriate for automation are identified. Machine learning models are then generated for the identified data input fields and are used to suggest responses including multiple recommended and ranked responses for the identified fields. The predicted responses are utilized to automate the process of completing the corresponding data input fields in a manner that improves both the efficiency and accuracy of form completion. For example, a form can include an automation user interface, such as an automation button to enable form automation using machine learning prediction. Once automation is enabled, a form is monitored for user interaction including user navigation of form elements and provided data input field responses. Fields that are particular pain points can be automatically identified and/or manually selected as candidates for automation. For example, a field with hundreds of potential responses that is tedious to complete is automatically identified as a candidate for automation. Once sufficient training data is collected by a monitoring process, machine learning prediction models are trained for the identified candidate data input fields. The models can be used to predict a single response, such as a default response, and/or suggest multiple recommended responses. For example, using the disclosed techniques, a small number of likely responses can be recommended and ranked for an automated data input field. The recommendations can narrow down the responses for a user completing the form to a small handful of strong choices from hundreds of possible options typically presented in a pull-down that is tedious to navigate. As another example, a prediction model can predict the email address to provide for an email data input field based at least in part on the responses provided for the form's other related data input fields and past form responses. A data input field that routinely takes a significant amount of time for a user to complete can be automatically identified and completion of the response can be automated using a generated machine learning prediction model. The results are more accurate and include timely collection of user data by applying the disclosed machine learning prediction techniques to the most appropriate data input fields.

In some embodiments, an indication to enable machine learning prediction is received for a form. For example, a digital computer form available to users includes a plurality of data input fields for collecting user responses. The digital form can include one or more user interface elements for enabling machine learning predictions. For example, an automation button can be included, for example, at the top or bottom of the form, to enable machine learning prediction for the form. As another example, an automation button can be included next to one or more data input fields to enable and/or configure machine learning prediction for the associated field. A user or administrator of the form can select the user interface element to indicate that machine learning prediction for the form should be enabled and/or configured.

In some embodiments, selection of the appropriate user interface element provides an indication to enable machine learning prediction for automating at least a portion of the completion for the form. For example, selecting a button next to an input response field can enable automation of the associated field. Similarly, selecting an automation button associated with the entire form can enable automation based on the context of the entire form. In some embodiments, behavior associated with the form is monitored. Once automation is configured, behavior, including form completion behavior from users and/or administrators, is monitored. For example, various properties of form completion can be monitored including the responses and properties of the responses provided for data input fields. In some embodiments, properties that are monitored can include the length of time it takes to complete a field, the number of revisions to a field, the number of incorrect responses for a field, the completion sequence of the response fields, and/or which user interface elements are accessed and how they are accessed for selecting responses for fields, among others. In various embodiments, different challenges and/or pain points for completing the form are identified by monitoring the behavior associated with utilizing the digital form.

In some embodiments, one or more of the plurality of data input fields are automatically selected based on an analysis of the monitored behavior. For example, one or more fields can be selected from identified pain points such as the time required to complete the field(s). A field that takes particularly long to complete can be a good candidate for machine learning prediction. As another example, fields are automatically selected based on the current state of the form when automation is enabled. For example, for a partially completed form, the automatically selected fields may be selected from the response fields that have yet to be completed. In some embodiments, one or more machine learning prediction models are automatically generated for at least a portion of the selected one or more of the plurality of data input fields. For example, a machine learning model is generated for a selected data input field. The model is trained and evaluated to determine whether the model can be used for automation. For example, in some embodiments, a model must have a prediction accuracy that exceeds a threshold amount before it is considered helpful to a user and can be used for automation. In some embodiments, multiple models are trained to identify one or more models accurate enough for automation for one or more of the data input fields. In some embodiments, in the event a model cannot accurately predict a response for a data input field, the model is rejected.

In some embodiments, at least a portion of the generated machine learning prediction models are allowed for use in providing one or more prediction results for one or more of the plurality of data input fields. For example, the machine learning models are used to predict responses for one or more data input fields. Instead of requiring a user to complete the data input field, one or more generated machine learning prediction models are used to predict one or more field responses. In some embodiments, more than one response is predicted for a field. For example, the responses may be shown in a user interface in ranked order and the user can select from the provided results. In various embodiments, the generated machine learning model is used to help automate the completion of digital forms. In some embodiments, the user submitted form responses can be used to retrain and/or refresh the training model.

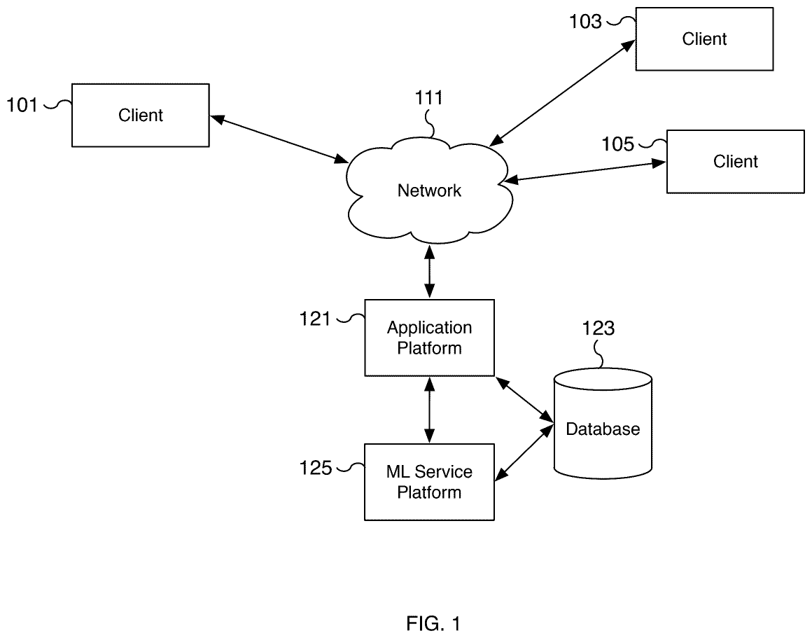

FIG. 1 is a block diagram illustrating an example of a network environment for automating data input field responses. In the example shown, clients 101, 103, and 105 access cloud-based application platform 121 via network 111. Network 111 can be a public or private network. In some embodiments, network 111 is a public network such as the Internet. Application platform 121 hosts cloud services such as a form application service for collecting user data input responses using digital computer forms. For example, a digital form that includes multiple data input fields for entering responses is provided via a web application hosted by application platform 121. Customers, users, and/or administrators of network clients such as clients 101, 103, and 105 provide responses to the data input fields. The responses are collected by the web application and can be stored in a database such as database 123. The collected responses can be further used to initiate a business process, such as directing an incident ticket, processing a travel itinerary, or updating entries for a configuration management database, etc. In various embodiments, one or more cloud services offered by application platform 121 are enabled with machine learning services offered by machine learning service platform 125. For example, a form application service hosted by application platform 121 can be automated using machine learning service platform 125 to suggest responses to one or more data input fields of a form.

In some embodiments, application platform 121 offers a form application service for collecting user form responses. The form application service can utilize an automation service that enables machine learning prediction for automating the response to data input fields. The automation service can include a monitoring service that monitors and analyzes user interaction with a form, including the response time and responses used to complete the provided fields of a form. In some embodiments, the monitored data is gathered and stored in database 123. The monitored data can be used to identify which fields can and/or should be automated. In various embodiments, the monitored data is used by machine learning service platform 125 to train one or more machine learning models to predict responses for one or more corresponding data input fields. The trained models are validated and selected based on prediction results and used to automate the completion of the digital form. For example, application platform 121 can utilize one or more trained models via machine learning service platform 125 to predict one or more data input field responses for a digital form.

In some embodiments, machine learning service platform 125 is a machine learning platform offering machine learning services including generating trained machine learning prediction models and/or determining prediction results using a generated model. Although depicted in FIG. 1 as a single element, machine learning service platform 125 may include multiple components including one or more servers such as one or more training and/or one or more prediction servers. Machine learning service platform 125 can also include additional components such as a scheduler component and/or machine learning model storage. In various embodiments, each of these components can function as separate functioning components such as separate servers or data stores and need not, for example, be limited to run on the same hardware server. In some embodiments, machine learning service platform 125 includes a cluster of training and prediction servers used to load balance training and prediction requests. Allocation of a particular training or prediction server can be assigned by a scheduling component in response to a training or prediction request. In various embodiments, machine learning service platform 125 includes a machine learning model data store for storing trained machine learning models. Data used to train machine learning models can be retrieved from a customer database such as database 123.

In some embodiments, machine learning service platform 125 is utilized to generate one or more machine learning prediction models for a cloud service of application platform 121. For example, the generated models can predict data input field responses and be used to automate the completion of a digital form. In the example shown, application platform 121, database 123, and machine learning services platform 125 are interconnected. For example, in various embodiments, machine learning services platform 125 can access and/or store data on database 123. Moreover, customer data stored in database 123 can be utilized to train a machine learning model using machine learning services platform 125 and application platform 121 can utilize machine learning service platform 125 for predicting machine learning results. In some embodiments, database 123 is a relational database such as a MySQL database. In various embodiments, database 123 responds to database queries such as SQL queries originating from application platform 121 and/or machine learning service platform 125.

Although single instances of some components have been shown to simplify the diagram of FIG. 1, additional instances of any of the components shown in FIG. 1 may also exist. For example, as previously discussed, application platform 121 and/or machine learning service platform 125 may include one or more different servers and/or multiple components. Similarly, database 123 may include one or more database servers and may not be directly connected to application platform 121 and/or machine learning service platform 125. For example, database 123 and its components may be replicated and/or distributed across multiple servers and/or components. In some embodiments, components not shown in FIG. 1 may also exist.

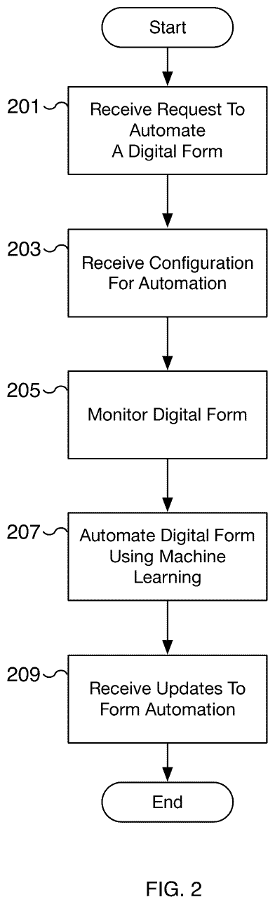

FIG. 2 is a flow chart illustrating an embodiment of a process for automating a digital form. In various embodiments, a form includes one or more automation user interface components to enable automation of form components such as data input fields. Using the process of FIG. 2, a form and its corresponding data input fields can be automated by first identifying fields appropriate for automation and predicting their responses. Responses to data input fields can be predicted using automatically generated machine learning models. The predicted responses to data input fields can be provided as default and/or suggested responses. In some embodiments, the models are generated using training data collected by monitoring the behaviors of users as they interact with a digital form. In some embodiments, the process of FIG. 2 is performed using application platform 121, database 123, and/or machine learning services platform 125 of FIG. 1.

At 201, a request to automate a digital form is received. For example, a user and/or administrator with the proper access permissions enables automation for a digital form hosted on an application platform such as application platform 121 of FIG. 1. In some embodiments, automation is enabled by the selection of an automation user interface component of the form. For example, a form toolbar or menu can include an automation button that when selected enables automation of the form. In some embodiments, the automation is enabled by first providing a process for a user to configure the parameters of automation. For example, a user can be directed to a user interface dialog for automation configuration. In some embodiments, an instance of an automation user interface component such as an automation button is located beside one or more data input fields. The selection of a field specific automation button can enable automation of the associated data input field, whereas the selection of a global form automation button can enable automation of multiple data input fields of the form.

At 203, a configuration for the automation is received. For example, a user can specify the configuration parameters for automation such as accuracy thresholds, monitoring requirements, which fields automation is enabled/disabled, etc. The configuration parameters are received at 203. In some embodiments, a user can configure an accuracy threshold that must be met before a generated machine learning model is utilized for predicting responses for a data input field. For example, a generated machine learning model can be discarded in response to a generated machine learning prediction model not meeting an accuracy threshold. In some embodiments, a trained model not meeting an accuracy threshold can be an indication that the field is not a good candidate for automation. In some embodiments, a user specifies parameters for monitoring behaviors associated with the form to determine whether sufficient training data has been collected. For example, a user can configure a monitoring count configuration parameter for monitoring of the form to require monitoring at least a threshold number of form interactions before generating a machine learning model. As another example, a user can configure a monitoring duration configuration parameter for monitoring of the form to require a threshold amount of time that monitoring must be performed before generating a machine learning model.

In some embodiments, the automation can be configured to automate responses based on the behaviors of a single identified user and/or a group of users. For example, once automation is enabled, the behaviors of a single identified user and/or the behaviors of a group of users are monitored and collected as potential training data. The monitoring configurations for data input fields can specify the requirements for generating machine learning models. For example, the models can be configured to predict behaviors of a single user or of a group of users, depending on which configuration is desired for which data input field.

In some embodiments, configuration parameters received for enabling automation include specific data input fields to consider for automation. The specific fields received may include a subset of the data input fields of the form. In some embodiments, the eligible fields for consideration are presented to the user via a configuration user interface dialog and a selection of data input fields presented in the dialog are received as configuration parameters. The received selection can be used as a candidate list of fields to consider for automation. For example, user behaviors associated with the selected fields can be monitored at 205.

At 205, a digital form is monitored. For example, behaviors associated with the form are monitored. In some embodiments, the behaviors of a single identified user or a group of users is monitored. The monitored behavior can include the responses provided for a data input field, the number of times a data input field is revised and/or edited, the sequence order the data input fields are completed and/or filled, the amount of time associated with completing a data input field, and the interaction pattern a user performs when interacting with a user interface element of a data input field, among others. In various embodiments, various interactions are monitored, and the corresponding data of the interactions is collected. In some embodiments, the behavior is monitored for a configured monitoring duration and/or until a threshold of particular interactions meets a configured monitoring count.

In some embodiments, the monitoring is based on the state of the form. For example, a form can have a state such as a completion state corresponding to which data input fields are blank, partially completed, completed, or another defined field completion state. In some embodiments, the state of a form is tracked and detailed monitoring is performed when the progress of the form is in and/or between certain states and/or completion states. For example, detailed monitoring for response behaviors can be performed for a form when two specific data input fields are completed but the remaining fields are blank and continued until a third specific field is completed. In various embodiments, the monitoring can be tied to the state of the form in order to reduce the amount of monitoring and associated data collection needed. In various embodiments, the collected data from monitoring can be used for training at 207. In some embodiments, the data collected is stored in a database such as database 123 of FIG. 1.

At 207, a digital form is automated using machine learning. For example, one or more data input fields are identified for training a machine learning model. In various embodiments, one or more machine learning models are trained for each identified data input field. The identified data input fields may be selected based on user selection and/or automatically. For example, data input fields can be automatically selected for training a machine learning model in the event a data input field is identified as a good candidate for prediction. In some embodiments, a good candidate for prediction includes data input fields that are tedious, difficult, and/or time consuming to complete. In some embodiments, a machine learning model is trained and then confirmed to meet an accuracy threshold. For example, an accuracy score is determined for each trained machine learning model. In some embodiments, a machine learning model that does not meet the accuracy threshold is discarded and not used for automation. Models that meet the accuracy threshold can be used to enable automation for the corresponding data input field. For example, the models can be used to predict responses to the corresponding data input field of a form. In some embodiments, the models are applied when the form is in the appropriate state or completion state. In some embodiments, more than one prediction response is provided. For example, a group of prediction responses can be provided in ranked order. In various embodiments, only responses with a high likelihood of being accurate are provided to the user from which to select from. Multiple models can be used to provide suggested responses for the same data input field. In various embodiments, the machine learning training and predictions are performed using machine learning services platform 125 of FIG. 1.

At 209, updates to the automation of the digital form are received. For example, once a form is enabled for automation, data monitoring can continue, and the responses from monitoring behaviors associated with the form can be collected. The data can be used for retraining, refreshing, and/or updating the appropriate trained machine learning model. In various embodiments, the updates to the automated digital form are received and can be applied to improve the automation.

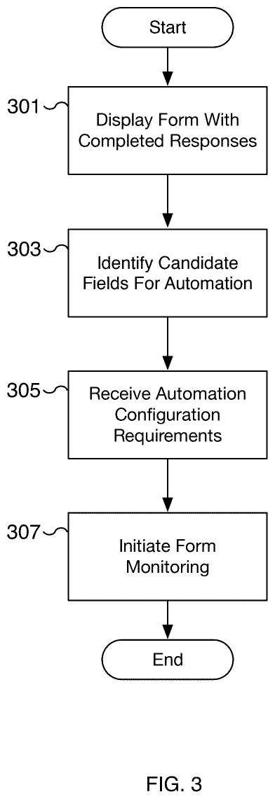

FIG. 3 is a flow chart illustrating an embodiment of a process for configuring the automation of a digital form. For example, using the process of FIG. 3, configuration parameters for enabling the automation of data input fields of a digital form are received and utilized to enable automation of form responses. The configuration can apply to the entire form and/or specific data input fields of the form. In some embodiments, the process of FIG. 3 is performed using application platform 121, database 123, and/or machine learning services platform 125 of FIG. 1. For example, configuration parameters may be received via application platform 121 of FIG. 1 and may be stored in database 123 of FIG. 1. In some embodiments, the process of FIG. 3 can be initiated by the selection of an automation user interface component of the form, such as by the selection of an enable automation button. Machine learning models can be trained according to the received configuration parameters using machine learning services platform 125 of FIG. 1. In some embodiments, the process of FIG. 3 is performed at steps 201 and/or 203 of FIG. 2.

At 301, the digital form is displayed with completed responses. For example, once automation is enabled, a user interface dialog displays the current state of the form with any provided responses. The provided responses can include completed responses. For example, a form with 10 data input fields may have three fields already completed when a user enables automation. The current completion state of the form includes three completed fields and seven blank fields. In some embodiments, a form can include partially completed responses in addition to blank and completed responses. Other data input field completion states may be appropriate as well. In the example, the form can be displayed with three completed data input fields and seven blank data input fields.

At 303, data input fields of the digital form that are eligible candidates for automation are identified. For example, each data input field of the form can be identified as a candidate for automation. In some embodiments, the eligible candidates are displayed in a user interface dialog and the user is provided with an opportunity to configure automation parameters. For example, an automation configuration user interface can be invoked to configure the training requirements for each eligible data input field. In some embodiments, the data input fields are automatically identified and each is automatically considered as a candidate for automation. In some embodiments, a user can actively enable and/or disable automation of certain fields. For example, an electronic signature field can be configured to always disable automation. With automation disabled, instead of auto-populating a user's electronic signature, a user would be required to manually enter their electronic signature as a response for the electronic signature data input field.

At 305, automation configuration requirements are received. For example, automation configuration requirements including machine learning training requirements are received. In some embodiments, the requirements are provided by a user via a configuration dialog and are received for each field selected and/or identified as a candidate for automation. In some embodiments, the default configuration parameters are used. In various embodiments, automation configuration requirements can include the amount of training data required to be collected before machine learning training is performed. For example, a length of time to monitor user behaviors and/or a number of interactions to monitor can be provided.

In various embodiments, additional configuration requirements are received. For example, requirements can include additional monitoring requirements, automation accuracy thresholds, which fields automation is enabled/disabled, etc. In some embodiments, a user can configure an accuracy threshold that must be met before a generated machine learning model is utilized for predicting responses for a data input field. A trained model not meeting an accuracy threshold can be discarded for use in automation. In some embodiments, the automation can be configured to automate responses based on the behaviors of a single identified user and/or a group of users. For example, a particular user or group of users may be identified as very skilled at categorizing incident reports especially when compared to all other users who happen to be very poor at the categorizing task and typically incur a high error rate. The automation configuration requirements can require that the behavior of the ideal user or a group of ideal users be used for training a machine learning model to predict responses for the data input field used to categorize the incident reports.

In some embodiments, a form state is received as part of the automation configuration requirements. The form state can describe the state of the form, including the completion state of the various data input fields of the form. In various embodiments, automation is only enabled for certain states of the form. By enabling automation for specific states of a form, the application of machine learning-based automation is directed to maximize the efficient use of available monitoring and machine learning services.

At 307, monitoring of the digital form is initiated. For example, using at least a portion of the configuration requirements received at 305, including monitoring requirements, monitoring of the digital form is initiated. In some embodiments, the monitoring of the digital form occurs in two stages, an observation stage to identify when to begin monitoring and the actual monitoring stage. A first stage is used to identify the current state of a form, such as the current completion state of a form. Once a current state of the form matches a form state specified by a monitoring configuration requirement received at 305, a second and more detailed monitoring stage is used to monitor behaviors associated with the form. In various embodiments, the monitoring may be initiated at application platform 121 and/or machine learning services platform 125 of FIG. 1. In some embodiments, the monitoring initiated at 307 is then performed at step 205 of FIG. 2.

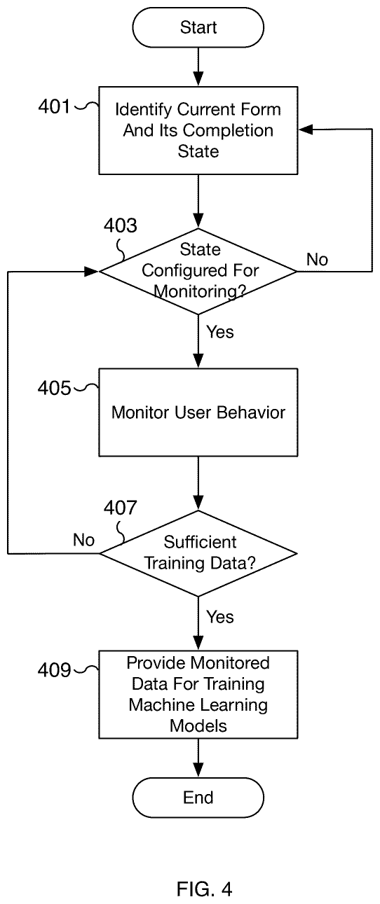

FIG. 4 is a flow chart illustrating an embodiment of a process for monitoring the behaviors associated with a digital form. Using the process of FIG. 4, user interactions with a form are monitored to identify fields for automation and to collect training data for predicting responses to fields. In various embodiments, the process of FIG. 4 may be performed with respect to one or more different users, depending on the desired automation. In some embodiments, the process of FIG. 4 is performed using application platform 121, database 123, and/or machine learning services platform 125 of FIG. 1. For example, portions of the monitoring process may be performed at application platform 121 of FIG. 1 and related monitoring requirements and/or collected data may be retrieved and/or stored in database 123 of FIG. 1. In some embodiments, the training data collected via the process of FIG. 4 is passed to machine learning services platform 125 of FIG. 1 for training a machine learning model. In some embodiments, the process of FIG. 4 is performed at step 205 of FIG. 2.

At 401, the current form and its completion state are identified. For example, the current state of a form is identified. In some embodiments, the state is based on the completion conditions of the data input fields of the form. Completion states for a data input field can include a blank field, a partially completed field, a completed field, and a blank field but with a previously deleted response, among others. The state may also be based on what field is currently active and/or selected for modification. In some embodiments, the state is based on the completion order of the fields and may include which fields have been accessed. In various embodiments, the state of the form is identified based on observing a user's behaviors with the form to identify when to begin monitoring. In various embodiments, the state of the form is tracked as a user progresses through filling out the form.

At 403, a determination is made whether the completion state of the digital form is a state configured for detailed monitoring. In the event the current state is configured for detailed monitoring, processing continues to 405. In the event the current state is not configured for monitoring, processing continues back to 401.

At 405, user behavior is monitored. For example, behaviors associated with the form are monitored. In some embodiments, the behaviors of a single identified user or a group of users is monitored. The monitored behavior can include the responses provided for a data input field, the number of times a data input field is revised and/or edited, the sequence order the data input fields are completed and/or filled, the amount of time associated with completing a data input field, and the interaction pattern a user performs when interacting with a user interface element of a data input field, among others. In various embodiments, various interactions are monitored, and the corresponding data of the interactions is collected. In some embodiments, the behavior is monitored for a configured monitoring duration and/or until a threshold of particular interactions meets a configured monitoring count. The monitored data can be collected as training data for training a machine learning prediction model. For example, user responses to data input fields, the order data input fields are completed, edits to responses for data input fields, etc. can be collected as training data. In some embodiments, the collected data is stored in a database such as database 123 of FIG. 1.

In some embodiments, behaviors are monitored to automatically determine candidate fields for automation. The candidate fields may correspond to particular pain points related to completing the form. For example, the time required to complete a field can be measured and monitored. Fields that take a particularly long time, such as exceeding a time requirement threshold, are identified as candidate fields for automation. In some embodiments, behaviors associated with user interactions with particular user interface components such as drop-down menus, date selection dialogs, response fields, etc. are monitored. The user interactions can be used to identify which fields are particular difficult, tedious, or challenging to complete and can be identified as candidates for automation.

At 407, a determination is made whether there is sufficient training data. In the event the training data is sufficient, processing proceeds to 409. For example, in some embodiments, the training data is sufficient in the event the amount of time spent capturing training data meets a monitoring duration configuration parameter, such as two weeks, 30 days, or another configured time length. In some embodiments, the training data is sufficient in the event the number of times a form interaction has been performed meets a monitoring count configuration parameter, for example, monitoring data corresponding to the form interaction has been captured a threshold number of times. In the event the training data is not sufficient, processing proceeds back to 403 where additional monitoring data can be captured, for example, on subsequent interactions with the form when the form in the appropriate completion state.

At 409, monitored data is provided for training machine learning models. For example, the monitoring data including training data captured at 405 is provided for training one or more machine learning prediction models. In some embodiments, the data can be used to train multiple models including one or more different model types for each candidate data input field. In various embodiments, the training data is provided to one or more training servers of a machine learning services platform such as machine learning services platform 125 of FIG. 1.

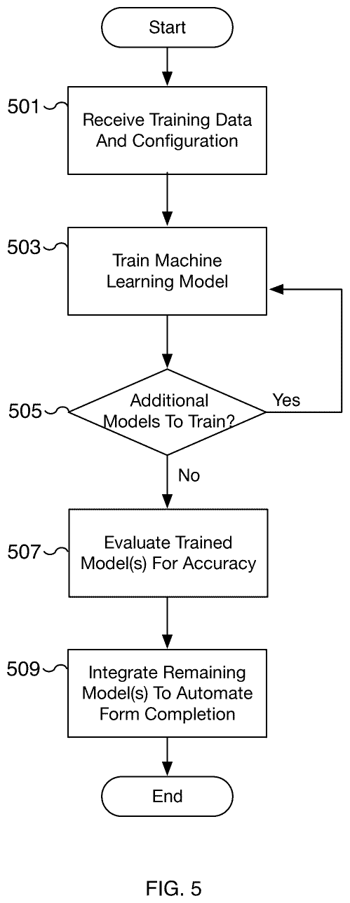

FIG. 5 is a flow chart illustrating an embodiment of a process for training a prediction model for automating a digital form. For example, one or more machine learning models are trained using the process of FIG. 5 and used to predict responses for data input fields of a digital form. In some embodiments, the process of FIG. 5 is performed using application platform 121, database 123, and/or machine learning services platform 125 of FIG. 1. For example, training data may be collected at application platform 121 of FIG. 1 and retrieved and/or stored in database 123 of FIG. 1. In some embodiments, the training data is provided to machine learning services platform 125 of FIG. 1, which utilizes the process of FIG. 5 to train one or more machine learning models. The trained models can be integrated into a digital form service hosted on application platform 121 of FIG. 1 for automating responses for digital form completion. In some embodiments, the process of FIG. 5 is performed at steps 207 and/or 209 of FIG. 2.

At 501, training data and configuration information is received. For example, training data and configuration information is received at a machine learning services platform. The training data can be utilized at 503 for training one or more models configured using the received configuration information. In some embodiments, the configuration information includes the identified data input field for prediction.

At 503, a machine learning model is trained. Using the received training data and configuration information, a machine learning model is trained. The model can be one of multiple models trained to predict responses to a particular data input field based on monitored behaviors. In some embodiments, the trained model can be one of a variety of different models, depending on the application. For example, the trained machine learning prediction model may utilize machine learning techniques based on classification, similarity, clustering, forecasting, or another type of machine learning technique. In various embodiments, once the model is trained it is also validated. In some embodiments, the model is trained using one or more training servers of machine learning services platform 125 of FIG. 1. In some embodiments, multiple models are trained in parallel at 503.

At 505, a determination is made whether there are additional models to train. In the event there are no additional models to train, processing continues to 507. In the event there are additional models to train, processing continues back to 503 where additional models are trained.

At 507, the trained models are evaluated for accuracy. For example, for each data input field, the models generated for the field are evaluated for accuracy. Models that perform poorly can be discarded and are not utilized for automation. In some embodiments, accuracy is determined by determining an accuracy score for each generated model. The accuracy score can represent how accurate the predictions made using the model are for a particular data input field. In some embodiments, the accuracy score is compared to an accuracy threshold received at 501. For example, a model with an accuracy score that does not meet an accuracy threshold can be discarded. In various embodiments, the accuracy threshold can be configured. In some embodiments, for a particular data input field, multiple models may have been generated. The models are analyzed and compared to determine which ones meet an appropriate accuracy threshold. Multiple models may meet accuracy requirements and may be retrained for predicting the responses for a particular data input field. In some embodiments, no models are sufficiently accurate at response prediction and a determination can be made that without additional information, such as additional training data, the data input field is not a good candidate for automation.

At 509, the remaining models are integrated to automate form completion. For example, the models evaluated and determined to meet accuracy requirements can be integrated into a cloud-based digital form service. In various embodiments, the models are used to predict responses to the corresponding data input field of a hosted digital form. In some embodiments, the prediction models are applied when the form is in the appropriate state or completion state. In some embodiments, more than one prediction response is provided for a particular data input field. For example, a group of prediction responses can be provided in ranked order. Multiple models can also be used to provide suggested responses for the same data input field. In various embodiments, the machine learning training and predictions are performed using machine learning services platform 125 of FIG. 1.

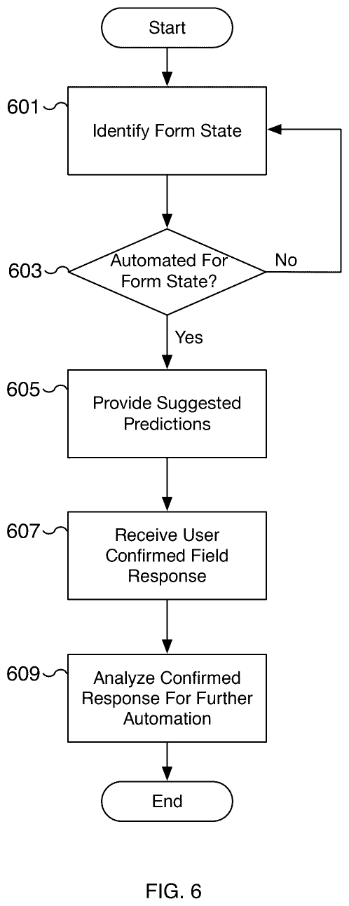

FIG. 6 is a flow chart illustrating an embodiment of a process for applying machine learning prediction for automating a digital form. Using the process of FIG. 6, one or more machine learning models trained and integrated into a form service using the process of FIG. 5 are used to automate form responses. The automated form responses can include suggested responses as well as automated default responses. In some embodiments, the process of FIG. 6 is performed using application platform 121, database 123, and/or machine learning services platform 125 of FIG. 1. For example, a service hosted on application platform 121 utilizes machine learning services platform 125 for predicting responses for data input fields of a hosted digital form. In some embodiments, form data including form automation configuration parameters can be stored and/or retrieved from database 123 of FIG. 1. In some embodiments, the process of FIG. 6 is performed at step 207 of FIG. 2.

At 601, the state of a form is identified. For example, user interaction of a form is observed, and a form state is determined based on the observed behavior. In various embodiments, the form state corresponds to a completion state of the form. The form state can be based on the completion status of each of the data input fields of a form as well as other factors of form completion. For example, in some embodiments, the form state may also be based on the current active data input field, such as which of the data input fields of the form is selected for editing. In various embodiments, the form state is determined in part by observing user interaction with a form from the moment a user begins to fill out the form.

At 603, a determination is made whether any data input fields are configured for automation for the current form state. In the event there are data input fields that are configured for automation for the current state of the form, processing continues to 605. In the event there are no data input fields configured for automation for the current state of the form, processing continues back to 601.

At 605, suggested predictions are provided. For example, response predictions are provided for any fields that are automated. In various embodiments, the automated fields are only enabled for automation when in the current form state. For example, predicted responses for the automated data input fields are provided when the form state changes to the associated automated form state. Predictions are determined by applying the corresponding trained machine learning models of the corresponding data input field using the form's current state information. For example, the form's current state information can include current user provided data input field responses and/or their completion status, among other input features associated with the form. In various embodiments, the form's current state information is used as inputs to the machine learning model for predicting a data input field's response. In some embodiments, the predicted response is a single response that is provided as a default response. Automated responses can also include one or more predicted responses provided by one or more different models for the corresponding field. The predicted responses can be provided as suggested responses and may be provided in ranked order. For example, a pull-down menu can include the top three predicted responses in ranked order as the top choices while also including the remaining response options under the predicted responses. In some embodiments, the predicted responses make up the most likely correct responses and their emphasized display in the pull-down menu allows a user to quickly filter the best responses from what can include hundreds of possible responses.

At 607, a user confirmed data input field response is received. For example, a user provides and submits a response for a data input field. The response can be a user entered response, a response selected from one or more predicted responses, or another response such as a default available response that is not a prediction result. In some embodiments, the response is a default predicted response. In various embodiments, the response for a data input field is received as a user confirmed response when a user confirms the response is accurate, for example, by selecting a confirmation, a submit, or another appropriate user interface element. In some embodiments, a confirmed data response may be later modified. In various embodiments, multiple confirmed responses corresponding to multiple data input fields are received together, for example, in the event a portion or an entire form that includes multiple completed data input fields is submitted at once.

At 609, the received confirmed response is analyzed for further automation. In some embodiments, the received confirmed responses are collected and can be used for machine learning training and/or to determine when and whether to perform additional training or retraining. For example, in some embodiments, the machine learning models are refreshed and/or updated using received confirmed responses. In some embodiments, the data is used to monitor the accuracy of the prediction results associated with a machine learning model. For example, the received confirmed responses can be analyzed to determine whether they match the predictions suggested at 605. In some embodiments, once the predicted responses are no longer sufficiently accurate, the machine learning model for the data input field is configured for retraining. Whether to enable/disable a data input field for monitoring, automation, and/or retraining can be automatically configured by analyzing the received confirmed responses. For example, in some embodiments, recent predictions must continue to meet an accuracy threshold, such as a user configurable accuracy threshold, before prediction is disabled, monitoring is enabled, and retraining is performed once sufficient training data is collected. In some embodiments, the settings are manually configured, for example, by utilizing an automation configuration user interface component. For example, a company may change a default provider of a service to a new vendor. Subsequent prediction results for the vendor data input field are likely to be wrong by predicting a response that is the name of the old vendor. With out-of-band knowledge of the change in vendor, an administrator can proactively enable retraining for the vendor data input field by manually configuring the automation settings for the field. In some embodiments, the prediction results for the example vendor data input field are disabled and monitoring for retraining the field is enabled. Once a sufficient amount of training data is collected, a new machine learning model is trained and used to automate the data input field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving user interactions with a plurality of data input fields of a digital form;
generating a suggested response using a machine learning model associated with a first data input field of the plurality of data input fields based on the user interactions; and
providing, via the digital form, the suggested response in association with the first data input field.

2. The method of claim 1, wherein a threshold number of user interactions are received before generating the suggested response using the machine learning model.

3. The method of claim 1, wherein a threshold amount of time elapses while receiving the user interactions before generating the suggested response using the machine learning model.

4. The method of claim 1, wherein the first data input field is selected based on a time required to complete the first data input field exceeding a time requirement threshold.

5. The method of claim 1, wherein the first data input field is selected based on a number of potential responses associated with the first data input field exceeding a threshold.

6. The method of claim 1, wherein the machine learning model is further associated with a second data input field of the plurality of data input fields.

7. The method of claim 1, wherein the suggested response is a default response.

8. The method of claim 1, wherein generating the suggested response using the machine learning model comprises generating a plurality of suggested responses comprising the suggested response, wherein the plurality of suggested responses are provided in association with the first data input field.

9. The method of claim 8, wherein the plurality of suggested responses are ranked.

10. The method of claim 1, further comprising updating the machine learning model based on subsequent user interactions using the provided suggested response.

11. A method comprising:
monitoring, by a monitoring service of an application platform, user interactions with a plurality of data input fields of a digital form;
identifying, by an automation service of the application platform based on the monitoring, a first data input field of the plurality of data input fields, wherein the first data input field is associated with respective user interactions;
training, by a machine learning service of the application platform, a machine learning model based on the respective user interactions associated with the first data input field; and
generating, via the trained machine learning model based on the digital form, a suggested response for the first data input field.

12. The method of claim 11, wherein monitoring the user interactions comprises at least one of: (i) monitoring a threshold number of user interactions before training the machine learning model; (ii) monitoring user interactions for a threshold amount of time before training the machine learning model; (iii) monitoring a time to complete a data input field of the plurality of data input fields; (iv) monitoring a number of revisions to a data input field of the plurality of data input fields; or (v) monitoring a number of incorrect response for a data input field of the plurality of data input fields.

13. The method of claim 11, wherein identifying the first data input field is based on at least one of: (i) a time required to complete the first data input field exceeding a time requirement threshold, or (ii) a number of potential responses for the first data input field exceeding a threshold.

14. The method of claim 11, further comprising determining an accuracy score for the machine learning model exceeds an accuracy threshold before generating the suggested response.

15. The method of claim 11, further comprising training a plurality of machine learning models, wherein each of the plurality of machine learning models is associated with a different input field of the plurality of input fields.

16. The method of claim 11, wherein the machine learning model is further trained based on user interactions associated with a second data input field of the plurality of data input fields.

17. The method of claim 11, further including updating the machine learning model based on subsequent user interactions based on the provided suggested response.

18. A non-transitory computer-readable medium storing program instructions that, when executed by one or more processors of a computing system, cause the computing system to perform operations comprising:
receiving user interactions with a plurality of data input fields of a digital form;
generating a suggested response using a machine learning model associated with a first data input field of the plurality of data input fields based on the user interactions; and
providing, via the digital form, the suggested response in association with the first data input field.

19. The non-transitory computer-readable medium of claim 18, wherein the operations further comprise:
receiving a request to automate the digital form;
receiving a configuration for automating the digital form;
monitoring the received user interactions based on the received configuration; and
training a machine learning model based on the monitored user interactions associated with the first data input field.

20. The non-transitory computer-readable medium of claim 19, wherein the operations further comprise:
training a plurality of additional machine learning models based on the monitored user interactions associated with the first data input field;
determining a first accuracy score for the machine learning model;
determining an accuracy score for each additional machine learning model in the plurality of additional machine learning models;
determining that the first accuracy score meets an accuracy threshold;
determining, for each additional machine learning model in the plurality of additional machine learning models, whether the respective accuracy score meets the accuracy threshold and, if not, discarding the additional machine learning model from the plurality of additional machine learning models;
generating additional suggested responses using each of the remaining additional machine learning models in the plurality of additional machine learning models; and
providing, via the digital form, the additional suggested responses in association with the first data input field.
